(19) United States
(12) Patent Application Publication
(10) Pub. No.: US 2024/0364160 A1
(43) Pub. Date: Oct. 31, 2024

(54) THERMAL MANAGEMENT FOR ROTOR OF ELECTRIC MOTOR

(71) Applicant: FCA US LLC, Auburn Hills, MI (US)

(72) Inventors: Prashant Modi, Rochester, MI (US); Dhafar Al-Ani, Troy, MI (US)

(21) Appl. No.: 18/308,722

(22) Filed: Apr. 28, 2023

(51) Int. Cl. H02K 1/32; H02K 9/19

(52) U.S. Cl. CPC H02K 1/32; H02K 9/19

(57) ABSTRACT

An electric motor having a rotor, a stator and a thermal management system is provided. The thermal management system includes: a hollow shaft having an internal channel and one or more shaft radial channels in communication with the internal channel and extending radially outward therefrom though the shaft; a rotor coupled to the hollow shaft for rotation therewith, the rotor including axial channels extending axially through a core of the rotor and one or more rotor radial channels corresponding to and aligning with the one or more shaft radial channels, the rotor radial channels being in communication with the axial channels and the internal channel of the shaft via the shaft radial channels; wherein the electric motor is adapted to receive oil into the hollow shaft and route the same to the rotor axial channels via the one or more shaft and rotor radial channels to cool the rotor core.

### FIELD

The present application generally relates to electric motors and, more particularly, to thermal management of a rotor of an electric motor, such as for electrified vehicle powertrains.

### BACKGROUND

A conventional electric motor includes a stator and a rotor. The stator is supplied with energy (i.e., current) to generate a magnetic field that causes the rotor to rotate and generate torque. The operation of an electric motor generates heat which causes the temperature of the components inside the electric motor to rise, such as the magnets in the rotor. Such magnets have thermal limits, above which they begin to lose their effectiveness (demanganization). As a result, conventional electric motors often limit their performance to maintain rotor temperatures below such thermal limits. One example implementation of an electric motor is in a vehicle's torque generating system or transmission for propulsion. Conventional electric motors are typically directly cooled by employing oil spray/splash in direct contact with the electric motor's outer axial ends. While such electric motor thermal management techniques do work for their intended purpose, there remains a desire for improvement in the relevant art.

### SUMMARY

According to one example aspect of the invention, a thermal management system for an electric motor of a vehicle is provided, where the electric motor includes a rotor and a stator. In one exemplary implementation, the thermal management system includes: a hollow shaft having an internal channel and one or more shaft radial channels in communication with the internal channel and extending radially outward therefrom though the motor shaft; a rotor coupled to the hollow shaft for rotation therewith, the rotor including axial channels extending axially through a core of the rotor and one or more rotor radial channels corresponding to and aligning with the one or more shaft radial channels, the rotor radial channels being in communication with the axial channels and the internal channel of the shaft via the shaft radial channels; wherein the electric motor is adapted to receive oil into the hollow shaft and route the same to the rotor axial channels via the shaft and rotor radial channels to cool the rotor core.

In some implementations, the hollow shaft is defined by the rotor. In some implementations, the rotor comprises first and second opposed axial ends and radial inner and outer exterior surfaces, and the one or more rotor radial channels are positioned between the first and second axial ends of the rotor. In some implementations, the one or more axial channels are positioned through the core of the rotor extending between and through the first and second axial ends of the rotor. In some implementations, the one or more shaft radial channels are positioned between the first and second axial ends of the rotor.

In some implementations, the rotor comprises magnets forming part of the rotor core assembly, and the one or more axial channels are positioned radially outboard of the radially inner exterior surface and radially inboard of the magnets.

In some implementations, the oil adapted to cool the rotor core flows through the one or more rotor radial channels into the one or more rotor axial channels and exits the rotor at the first and second axial ends, where said oil contacts the first and second axial ends of the rotor thereby providing further cooling to the rotor.

In some implementations, the one or more rotor axial channels comprise eight axial channels circumferentially spaced apart around the rotor. In some implementations, the one or more rotor radial channels comprise eight rotor radial channels, each of the eight rotor radial channels in fluid communication with a respective one of the eight axial channels. In some implementations, the eight rotor radial channels are axially aligned with each other between the rotor first and second axial ends.

In some implementations, the one or more rotor axial channels comprise four axial channels circumferentially spaced apart around the rotor, and wherein the one or more rotor radial channels comprises four radial channels, each of the four radial channels in fluid communication with a respective one of the four axial channels. In some implementations, at least two of the rotor radial channels are axially spaced apart from each other along a longitudinal axis of the electric motor.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is an example radial cross-sectional schematic view of an electric motor according to the prior art;

FIG. 2 is an example axial cross-sectional schematic view of the electric motor according to the prior art;

FIG. 3 is an example radial cross-sectional schematic view of a rotor of the electric motor of FIGS. 1 and 2;

FIG. 4 is an example axial cross-sectional schematic view of an improved electric motor having the improved thermal management system including one or more radial channels for supplying cooling fluid to rotor axial holes according to the principles of the present application;

FIG. 5A is an example axial cross-sectional schematic view of a rotor of the improved electric motor and FIG. 5B is a corresponding radial cross-sectional schematic view of the rotor showing aspects of the improved thermal management system including one or more radial channels for supplying cooling fluid to rotor axial holes according to the principles of the present application;

FIG. 6A is an example axial cross-sectional schematic view of a rotor of the improved electric motor and FIG. 6B is a corresponding radial cross-sectional schematic view of the rotor showing aspects of the improved thermal management system including one or more radial channels for supplying cooling fluid to rotor axial holes according to the principles of the present application;

FIG. 7A is an example axial cross-sectional schematic view of a rotor of the improved electric motor and FIG. 7B is a corresponding radial cross-sectional schematic view of the rotor showing aspects of the improved thermal management system including one or more radial channels for supplying cooling fluid to rotor axial holes according to the principles of the present application;

FIG. 7C is an example axial cross-sectional schematic view of a rotor of the improved electric motor and FIG. 7D is a corresponding radial cross-sectional schematic view of the rotor showing aspects of the improved thermal management system including one or more radial channels for supplying cooling fluid to rotor axial holes according to the principles of the present application; and

FIGS. 8A-8L illustrates various example channel shapes that may be formed in the rotor laminations to form the cross-sectional shape of the one or more radial oil supply channels of the improved rotor in accordance with the principles of the present application.

### DETAILED DESCRIPTION

As previously discussed, the operation of an electric motor generates heat which causes the temperature of the components inside the electric motor to rise. The two important components in the electric motor that need to be cooled are the magnets that are housed within the rotor and copper windings in the stator. Certain magnets in the rotor are typically demagnetized at temperatures above ˜150 degrees Celsius (based on the type and grade of magnet) and electric motor operation is often constrained to ensure that the magnet temperature does not exceed this threshold. The proposed thermal management system of the present application addresses the cooling of the rotor components in the electric motor by using a novel rotor and shaft architecture for a unique cooling path for cooling oil to cool the rotor.

A conventional electric motor thermal management technique is oil cooling by spraying/splashing. Oil cooling architectures use oil spray/splash directly on the motor surfaces for cooling, such as typically the axial ends of the rotor and stator. The heat is dissipated from contact of the cooling oil and the heat sources. This method is typically referred to as “direct-oil-spray-cooling”. One main approach is oil spray from the center towards the stator, driven by rotor rotation. In this approach, the oil is sprayed from the shaft ends towards the end-windings and stator laminations. In this case oil spray is driven by centrifugal forces caused by the rotation of the rotor. This approach attempts to cool the rotor by heat transfer via external rotor surfaces. The external rotor surfaces are mainly the rotor axial ends, exposed to the cooling oil.

Most of the direct-oil-spray-cooling methods described previously cool the rotor by heat transfer from the external end surfaces. For rotors made by stacking steel laminations, the axial thermal conductivity of the rotor is typically an order lower than the radial and circumferential thermal conductivities. This results in elevated temperatures in the core of the rotor. As a result, improved electric motor (rotor) thermal management techniques are presented. These techniques involve cooling the rotor (and in particular the rotor core) by routing oil flow through internal axial channels of the rotor fluidly connecting an oil supply channel of the electric motor's central shaft and axial channels spaced radially outward from the central axis of the electric motor.

This improved thermal management system can be applied to various types of electric motors or machines including, but not limited to Interior Permanent Magnet (IPM), Surface-mounted Permanent Magnet (SPM), Induction Machine (IM), Switching reluctance Machine (SRM) Permanent Magnet-Assisted Synchronous Reluctance Machine (PMSRM), Wound Rotor Synchronous Machine, Axial Flux Machine, and Externally Excited Synchronous Machine.

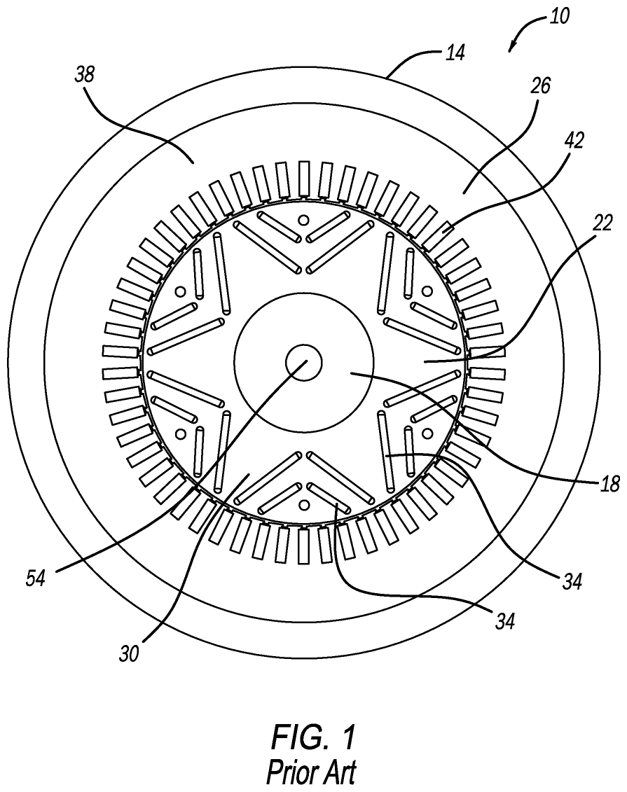

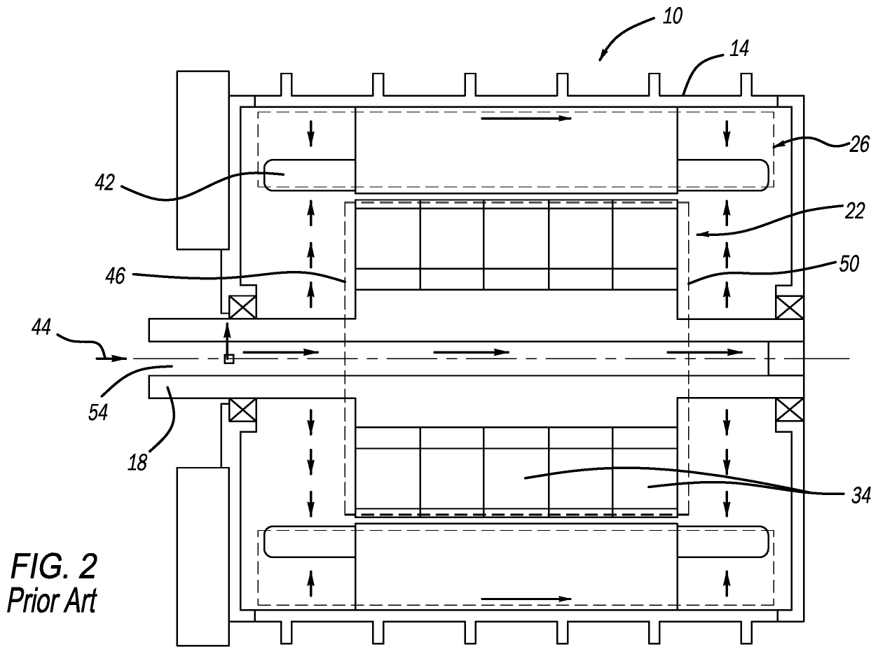

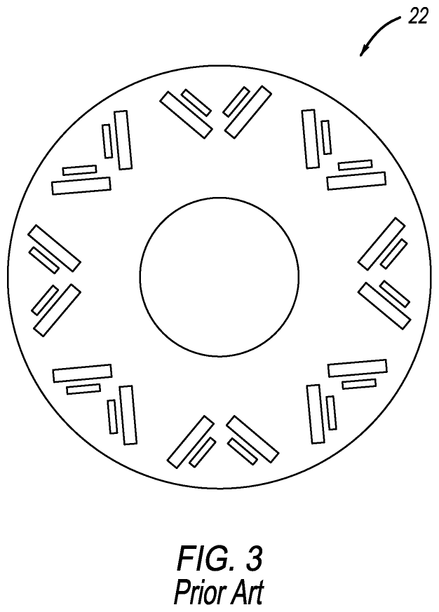

Turning now to the drawings, FIGS. 1 and 2 show certain main components of a conventional electric motor identified at reference numeral 10. The electric motor 10 includes an outer housing 14, a central hollow shaft 18 supporting a rotor 22, and a stator 26. In one example implementation, the rotor 22 includes and is formed by a plurality of rotor lamination plates 30 and magnets 34, as is known in the art. In this example implementation, the stator 26 includes stator laminations 38 and windings 42, as is also known in the art. In this example, the rotor 22 and stator 26 are cooled using the direct-oil-spray technique discussed above where oil 44 is splashed on the respective axial ends 46, 50 of the rotor 22 and stator 26. FIG. 3 schematically illustrates a radial sectional view of the rotor 22 by itself, in the form of a rotor lamination plate, separated from the electric motor 10.

The electric motor 10 can be utilized in an electrified powertrain of a vehicle. The electrified powertrain, in one example is controlled by one or more controllers or a control system so as to achieve a desired/requested amount of drive torque in response to a driver pedal request. The powertrain may include one or more electric motors 10 that generate drive torque and are selectively coupled to or form part of a transmission for transfer of drive torque to a driveline. An oil supply system may be controlled by the controller to supply/recirculate oil to the one or more electric motors 10, such as to a hollow center 54 of shaft 18.

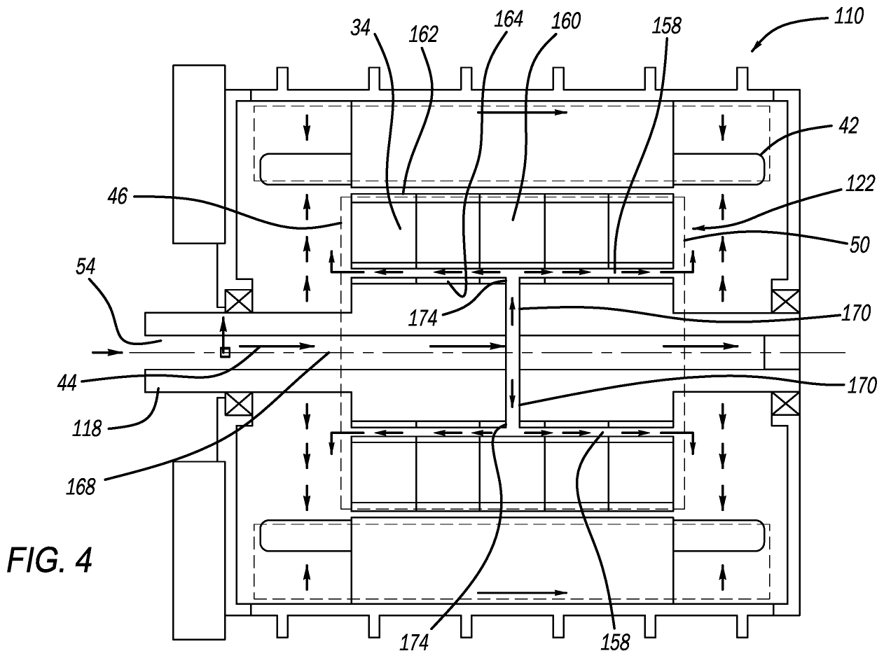

Turning now to FIG. 4 and with continuing reference to FIGS. 1-3, an improved electric motor 110 will now be discussed in accordance with the principles of the present application. Components of electric motor 110 that are similar or the same as in electric motor 10 will retain the same reference numerals.

Electric motor 110 includes an improved shaft 118 and rotor assembly 122. The rotor assembly 122 includes, in addition to the features described for rotor 22 of electric motor 10, one or more axial holes/channels or slots 158 radially spaced apart from the central hollow shaft 118. In the example illustrated, there are eight axial channels 158 radially spaced apart from shaft 118 and positioned in a core of the rotor assembly 122.

In this example, the axial channels 158 are equally radially spaced apart from a central axis 168 of the motor 110, as well as are circumferentially equally spaced from each other. It will be appreciated that different numbers of axial channels 158 may be used depending on different rotor sizes and performance characteristics, for example. These axial channels 158 serve two purposes-rotor weight reduction to increase efficiency and cooling of the rotor core area 160 via oil 44 flowing through such axial channels 158, as will be discussed in greater detail below. The rotor core area 160 will be understood to include an area of the rotor 122 encompassing the magnets 34 and located between the axial ends 46, 50 and inner and outer radial surfaces 162, 164.

In order to route the oil 44 flowing/present in the hollow area 54 of central shaft 118, the shaft 118 includes one or more shaft radial channels or holes 170 in fluid communication with a corresponding one or more of the rotor radial holes or channels 174, which are in fluid communication with the one or more of the rotor axial channels 158. Thus, oil flowing into hollow shaft 118 will flow radially outward via channels 170, 174 into axial channels 158 for improved cooling of the rotor core proximate the magnets 34.

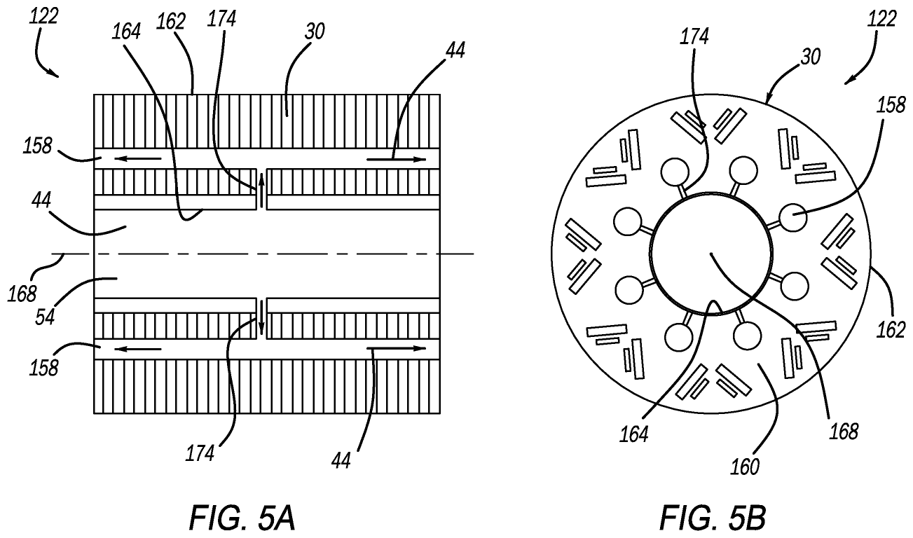

With additional reference to FIGS. 5A-7D and continuing reference to FIG. 4, the improved electric motor 110 can include different arrangements of the radial and axial oil cooling channels 174, 158 depending on the particular performance characteristics and design of the electric motor 110. For example, FIGS. 4A-4B and 5A-5B illustrate an improved cooling arrangement where one radial shaft and rotor channel 170, 174 are utilized to supply each of the rotor axial channels 158. As a result, there are eight of such aligned radial shaft and rotor channels 170, 174 corresponding to the exemplary eight rotor axial channels 158. In the example illustrated in FIGS. 4A-4B and 5A-5B, the radial shaft and rotor channels 170, 174 are axially aligned with each other relative to the rotor ends 46, 50.

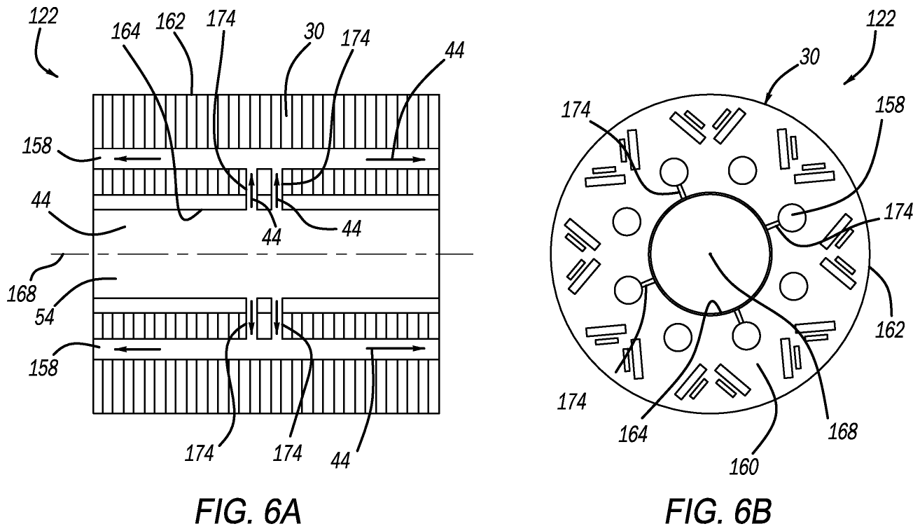

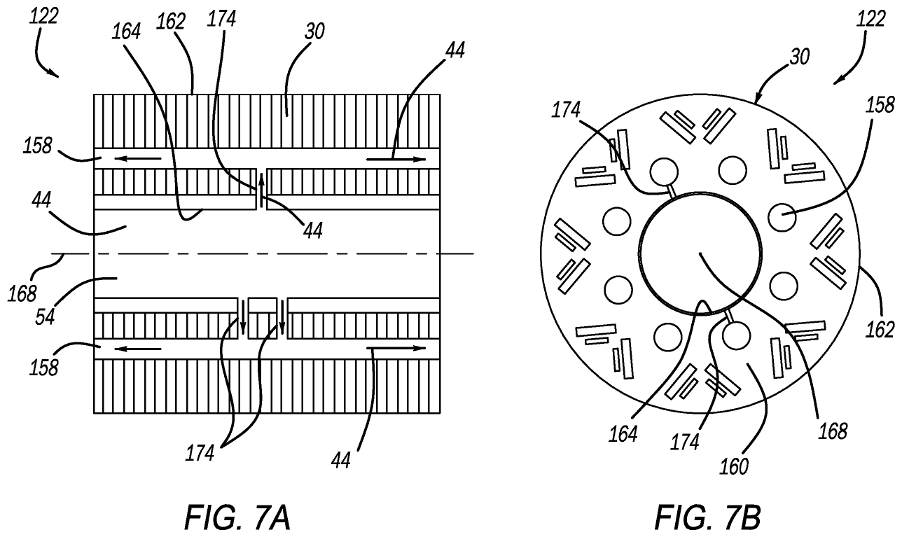

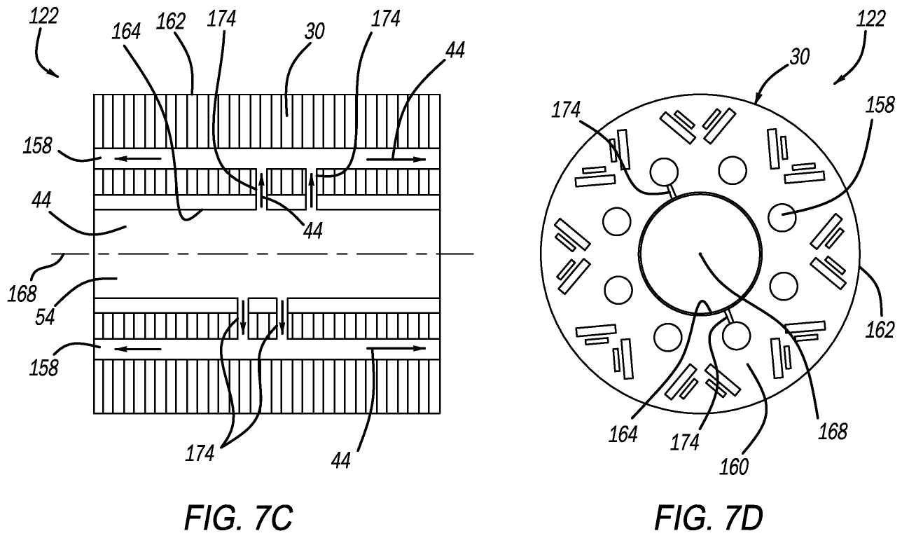

It will be appreciated that other rotor cooling channel arrangements are contemplated and may be beneficial depending on design and performance characteristics of the electric motor 110, particularly the rotor assembly 122. For example, only some of the available rotor axial channels 158 may be supplied with oil 44 via radial channels 170,174, such as is illustrated in FIGS. 6A-6B and 7A-7D. FIGS. 6A-6B show an alternating oil channel supply configuration with two sets of diagonally opposed axial channels 158 being supplied with oil 44. Further, some or all of the rotor axial channels 158 may be supplied with more than one axially spaced apart combination of radial channels 170, 174. This may include all rotor axial oil channels 158 having more than one combination of radial supply channels 170, 174, or only some of the rotor axial channels 158 having multiple combinations of radial supply channels 170, 174.

The rotor assembly 122 can be formed using various techniques including through the use of a plurality of stacked rotor lamination plates 30. In this regard, the radial sectional schematic views of FIGS. 5A-7D can also be viewed as a single lamination plate 30 with various cutouts that are used to form pockets for the magnets and the previously discussed rotor axial and radial channels 158, 174, respectively. The axial sectional schematic views of FIGS. 5A-7D illustrate a complete stack of lamination plates 30 coupled together to form the rotor core and the previously discussed rotor axial and radial channels 158, 174, respectively.

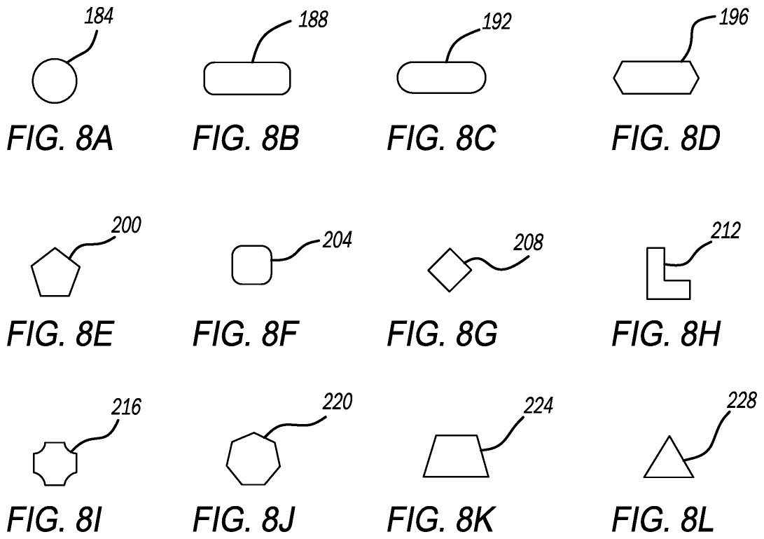

With reference now to FIGS. 8A-8L and continuing reference to FIGS. 4-7D, various alternative shapes (in cross-section) for radial channels 174 are illustrated. The shapes shown in FIGS. 8A-8L represent the shape cut out or stamped into the rotor laminations 30 that, when stacked together as shown in FIGS. 4-7D, form the rotor axial and radial channels 158, 174, respectively. The shapes include a circular shape 184, a rectangular shape 188, a slot with rounded ends 192, a slot with converging ends 196, a pentagonal shape 200, a square shape 204, a diamond or rhombus shape 208, an L-shape or chevron shape 212, a cross shape 216, a heptagonal shape 220, a trapezoidal shape 224, and a triangular shape 228. It will be appreciated that channels 174 are not limited to the described shapes and could have various other shapes. Moreover, it will also be appreciated that each stator lamination 30 may have various combinations of shapes.

In operation, such as operation of the electrified vehicle using the electric motor 110, oil 44 from the oil supply system is received in the hollow center 54 of rotor shaft 118. The oil 44 therein then flows via pressure and/or centrifugal force through the one or more shaft radial channels 170 and corresponding rotor radial channels 174 into the one or more rotor axial channels 158. The oil flowing through the rotor radial channels 174 and rotor axial channels 158 cools the rotor core area 160, including magnets 34, via heat transfer. This rotor core area cooling has been shown to be significantly more effective than merely cooling the axial ends of the rotor 22/122 of the electric motor 10/110. As a result of this improved cooling, the power and efficiency of the motor can be increased thereby using more potential of the rotor magnets without breaching the thermal limits of such magnets.

The rotor oil channels running axially enhance heat transfer from the bulk of the rotor (e.g., rotor core) as opposed to cooling only the rotor axial ends. These internal rotor cooling channels run closer to the permanent magnets and are thus more effective at transferring heat from the magnets. The overall surface area available for heat transfer is enhanced from the rotor internal cooling channels while retaining the ability to cool the rotor from external surfaces as well. Moreover, as the rotational speed of the rotor increases, the centrifugal forces increase thus providing for greater oil flow through the radial channels and into the axial channels, which increases cooling performance as the electric motor temperature increases, all without requiring any additional hardware. The proposed design also enables delivery of the coolest oil in the system to the rotor core as opposed to relying solely on oil splashed from housing/stator surface which will be warmer.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An electric motor having a thermal management system and for use in an electrified vehicle, the electric motor including a rotor and a stator, the thermal management system comprising:
a hollow shaft having an internal channel and one or more shaft radial channels in communication with the internal channel and extending radially outward therefrom though the shaft; and
the rotor coupled to the hollow shaft for rotation therewith, the rotor including axial channels extending axially through a core of the rotor and one or more rotor radial channels corresponding to and aligning with the one or more shaft radial channels, the rotor radial channels being in communication with the axial channels and the internal channel of the hollow shaft via the shaft radial channels;
wherein the electric motor is adapted to receive cooling oil into the hollow shaft and route the same to the rotor axial channels via the one or more shaft and rotor radial channels to cool the rotor core.

2. The electric motor of claim 1, wherein the hollow shaft is defined by the rotor.

3. The electric motor of claim 1, wherein the rotor comprises first and second opposed axial ends and radial inner and outer exterior surfaces, and wherein the one or more rotor radial channels are positioned between the first and second axial ends of the rotor.

4. The electric motor of claim 3, wherein the axial channels are positioned through the core of the rotor and extending between and through the first and second axial ends of the rotor.

5. The electric motor of claim 3, wherein the one or more shaft radial channels are positioned between the first and second axial ends of the rotor.

6. The electric motor of claim 3, wherein the rotor comprises magnets forming part of the rotor core, and wherein the axial channels are positioned radially outboard of the radially inner exterior surface and radially inboard of the magnets.

7. The electric motor of claim 3, wherein the oil adapted to cool the rotor core flows through the one or more rotor radial channels into the rotor axial channels and exits the rotor at the first and second axial ends, where said oil contacts the first and second axial ends of the rotor thereby providing further cooling to the rotor.

8. The electric motor of claim 1, wherein the rotor axial channels comprise eight rotor axial channels circumferentially spaced apart around the rotor.

9. The electric motor of claim 8, wherein the one or more rotor radial channels comprises eight rotor radial channels, each of the eight rotor radial channels in fluid communication with a respective one of the eight rotor axial channels.

10. The electric motor of claim 9, wherein the eight rotor radial channels are axially aligned with each other between the rotor first and second axial ends.

11. The electric motor of claim 1, wherein the rotor axial channels comprise four rotor axial channels circumferentially spaced apart around the rotor, and wherein the one or more rotor radial channels comprise four rotor radial channels, each of the four rotor radial channels in fluid communication with a respective one of the four rotor axial channels.

12. The electric motor of claim 10, wherein at least two of the rotor radial channels are axially spaced apart from each other along a longitudinal axis of the electric motor.
